(19) United States
(12) Patent Application Publication
(10) Pub. No.: US 2008/0255290 A1
(43) Pub. Date: Oct. 16, 2008

(54) Method of Dust Abatement

(75) Inventors: Christian Rath, Crown Point, IN (US); Andrew P. Verrall, Crown Point, IN (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: MONOSOL, LLC, Merrillville, IN (US)

(21) Appl. No.: 12/089,123

(22) PCT Filed: Dec. 5, 2006
(86) PCT No.: PCT/US06/61602

§ 371 Date: May 13, 2008

(30) Foreign Application Priority Data
Dec. 8, 2005 (US) 11298269

(51) Int. Cl. C08K 3/34; C08F 116/06; C08L 29/04

(52) U.S. Cl. 524/445; 525/56; 524/557

(57) ABSTRACT

A method of dust abatement, including applying and reapplying to a surface having particulate material a single-phase solution including a water-soluble polymer selected from the group consisting of polyvinyl alcohol, derivatives thereof, and combinations thereof, at a rate of 0.1 g/m to 6 g/m², on a dry basis, and suitable solutions for the method optionally including surfactants, plasticizers, tackifying agents, and nanoclays, are disclosed.

### BACKGROUND

1. Field of the Disclosure

The disclosure relates generally to suppression of dust and stabilization of masses of small particulates such as sand and soil against disruption. More particularly, the disclosure relates to a method of suppressing creation of airborne particulates by applying a solution of a water-soluble polymer to a substrate of loose particulates.

2. Brief Description of Related Technology

Dust, finely particulate solid matter, develops naturally in denuded or sparsely vegetated areas and in most unpaved, sparsely vegetated areas. Dust is also created in unsurfaced areas subjected to concentrated foot or vehicular traffic, and is usually a problem on shoulders of surfaced airport and heliport traffic areas. Dust control becomes desirable when man needs to occupy land areas adjacent to the dust producing areas. The control of dust is also an important factor to consider for lengthening the life of vehicles and their engines.

A “dust palliative” (or “palliative”, in context) is a material applied to a soil surface to prevent soil particles from becoming airborne. The following additional terms have been used to indicate a dust control material: dustproofer, spray or soil stabilizer, dust control agent, and dust abatement.

In a surface penetration method, the dust palliative, a liquid, frequently aqueous, is applied directly on the soil surface by spraying or sprinkling and is allowed to penetrate the surface. Previously-known dust palliatives for penetration of the soil surface include bitumens (cutback asphalts, emulsified asphalts, and road tars), resins (resin-petroleum-water emulsion, lignin, concrete curing compounds), salts (calcium chloride brine, sodium chloride brine, magnesium chloride brine), and water.

In a surface-blanket method, aggregates, prefabricated membranes and mesh, or surface treatments are used to create a surface blanket to control dust. Liquid surface treatments include use of bitumen (liquid asphalt) and polyvinyl acetates.

It has been suggested that modifying water to reduce its evaporation and run-off tendency would improve its usefulness in dust suppression. The prior art has taught the use of dilatant solutions of polyvinyl alcohol crosslinked with borates or boric acid, with particular application rates. The prior art has also taught the use of polymer emulsions, such as polyvinyl acetate emulsions, with particular application rates.

### SUMMARY

One aspect of the disclosure provides a method of dust abatement, including the step of applying to a substrate having particulate material a single-phase solution including a water-soluble polymer at a rate of 10 g/m² to 150 g/m², on a dry basis. The water-soluble polymer can be polyvinyl alcohol, or a derivative thereof.

Another aspect of the disclosure provides a method of dust abatement, including the step of applying to a substrate having particulate material a single-phase solution including a water-soluble polymer at a rate of 0.1 g/m² to 10 g/m², on a dry basis. The water-soluble polymer can be polyvinyl alcohol, or a derivative thereof. The method further includes the preferred step of reapplying to the surface the solution at a rate of 0.1 g/m² to 10 g/m², on a dry basis, wherein the elapsed time between application and reapplication is sufficient to allow the previous application to substantially dry, in order to build up a greater amount of polymer on the substrate.

Further aspects and advantages will be apparent to those of ordinary skill in the art from a review of the following detailed description. While the method is susceptible of embodiments in various forms, the description hereafter includes specific embodiments with the understanding that the disclosure is illustrative, and is not intended to limit the invention to the specific embodiments described herein.

### DETAILED DESCRIPTION

The method and compositions described herein are useful for suppression of dust (suppressing creation of airborne particulates) and stabilization of masses of small particulates such as sand and soil against disruption, such as by wind force. The method includes applying a solution of a water-soluble polymer to a substrate which includes loose particulates.

The general method includes applying to a surface including particulate material a single-phase solution including a water-soluble polymer such as polyvinyl alcohol (PVOH), derivatives thereof, and combinations of the foregoing. The method does not involve use of a polymer emulsion.

### Water-Soluble Polymer Solution

In one embodiment the polymer will consist essentially of, or consist only of, PVOH and/or a copolymer thereof. Preferably, the polymer will consist essentially of, or consist only of, PVOH. if polyvinyl alcohol or a copolymer thereof is used, then the PVOH can be partially or fully hydrolyzed. Polyvinyl alcohol (PVOH) is a synthetic resin generally prepared by the alcoholysis, usually termed hydrolysis or saponification, of polyvinyl acetate.

Fully hydrolyzed PVOH, where virtually all the acetate groups have been converted to alcohol groups (e.g., 98% or greater degree of hydrolysis), is a strongly hydrogen-bonded, highly crystalline polymer which dissolves only in hot water—e.g., rapid dissolution at temperatures of about 60° C. and greater.

If a sufficient number of acetate groups are allowed to remain after the hydrolysis of polyvinyl acetate, the PVOH polymer then being known as partially hydrolyzed, it is more weakly hydrogen-bonded and less crystalline and is soluble in cold water—e.g., rapid dissolution at temperatures of about 10° C. and greater. Cold-water soluble polymers are preferred.

Both fully and partially hydrolyzed PVOH types are commonly referred to as PVOH homopolymers although the partially hydrolyzed type is technically a vinyl alcohol-vinyl acetate copolymer.

An intermediate cold/hot water soluble polymer can include, for example, blends of partially-hydrolyzed PVOH (e.g., with degrees of hydrolysis of about 94% to about 98%), and is readily soluble only in warm water—e.g., rapid dissolution at temperatures of about 40° C. and greater.

The term PVOH copolymer is generally used to describe polymers that are derived by the hydrolysis of a copolymer of a vinyl ester, typically vinyl acetate, and another monomer. PVOH copolymers can be tailored to desired film characteristics by varying the kind and quantity of copolymerized monomers. Examples of copolymerizations are those of vinyl acetate with a carboxylic acid or with an ester of a carboxylic acid. Again, if the hydrolysis of acetate groups in these copolymers is only partial, then the resulting polymer could also be described as a PVOH terpolymer-having vinyl acetate, vinyl alcohol, and carboxylic acid groups-although it is commonly referred to as a copolymer.

The water-soluble polymer preferably is selected to provide a 4% solution viscosity in a range of about 5 cP to about 40 cP at 20° C., more preferably about 10 cP to about 30 cP at 20° C.

The method and solution are contemplated to include embodiments including any combination of one or more of the additional optional elements, features, and steps further described below, unless stated otherwise.

The solution is preferably essentially free of crosslinking agents, or completely free of crosslinking agents for the water-soluble polymer. Use of a partially-hydrolyzed PVOH (or copolymer derivative) without crosslinking agents allows for stabilization of soil and other substrates against creation of dust, and also allows for the repair of portions of the substrate which become destabilized, such as by vehicular traffic. The process of repairing the substrate can simply include applying a fine mist of water, to re-bind the particles together with the existing water-soluble polymer and optional agents.

In one type of embodiment, however, only a small amount of a weak crosslinking agent will be used.

For PVOH as the water-soluble polymer, crosslinking agents can be selected from any chemical agent that can form chemical bonds with the hydroxyl groups of PVOH. Such crosslinking agents include, for example, monoaldehydes (e.g., formaldehyde and hydroxyacetaldehyde), dialdehydes (e.g., glyoxal, glutaraldehyde and succinic dialdehyde), aldehyde-containing resins (e.g., trimethylol melamine), dicarboxylic acids (e.g., maleic, oxalic, malonic and succinic acids), citric acid, glycidyl and other difunctional methacrylates, N-lactam carboxylates, dithiols (e.g., m-benzodithiol), boric acid and borates, ammonium zirconium carbonate, inorganic polyions (e.g., molybdate and tungstate), cupric salts and other Group 1B salts, and polyamide-epichlorohydrin resin (polyazetidine prepolymer).

Rather than those crosslinking agents which undergo direct condensation reactions with hydroxyl groups (such as esterification and acetalization reactions with carboxylic acids and aldehydes, respectively), preferred crosslinking agents—for reasons of solution stability and rheology - are those that have one or more of the following functionalities: those that form complexes via labile polar covalent interactions, those that crosslink via ionic interactions, those that crosslink via hydrogen bonding interactions, and combinations of such crosslinking agents. Examples of such preferred crosslinking agents are borates, boric acid, ammonium zirconium carbonate, inorganic polyions such as molybdate and tungstate, cupric salts and other Group 1B salts, and polyamide-epichlorohydrin resin, and combinations thereof. Water-soluble polyamide-epichlorohydrin is available under the trade name POLYCUP 172 by Hercules, Inc. of Wilmington, Del. A particularly preferred crosslinking agent for PVOH is boric acid.

The crosslinking agent, when used, is present in an amount of less than 5 wt. %, based on the weight of the water-soluble polymer, such as PVOH. In addition, or in an alternative embodiment, the crosslinking agent, when used, is present in an amount of less than 0.5 wt. %, based on the weight of the solution.

The solution can optionally include a plasticizer. The plasticizer aids in making the bonds formed between the particulate matter more flexible and, thus, less subject to fracture. Glycerin is a preferred plasticizer. With PVOH, for example, in preferred embodiments glycerin is used in an amount from about 5 percent by weight (wt. %) to about 40 wt. % of the solution, on a dry basis. Other plasticizers suitable for use with PVOH are known in the art and are contemplated for use in the solution described herein.

The solution can optionally include a surfactant. The surfactant can aid in wetting out of the solution on the particles and penetration into a thickness of the substrate. Suitable surfactants may include the nonionic, cationic, anionic and zwitterionic classes. Preferably, the surfactants will be of the nonionic, cationic or zwitterionic classes or combinations of these. Suitable surfactants include, but are not limited to, polyoxyethylenated polyoxypropylene glycols, alcohol ethoxylates, alkylphenol ethoxylates, tertiary acetylenic glycols and alkanolamides (nonionics), polyoxyethylenated amines, quaternary ammonium salts and quaternized polyoxyethylenated amines (cationics), and amine oxides, N-alkylbetaines and sulfobetaines (zwitterionics). Preferred surfactants are alcohol ethoxylates, quaternary ammonium salts and amine oxides. Preferably, the surfactant has a hydrophile-lipophile balance (HLB) of 10 or greater, more preferably greater than 10.

The solution can optionally include a tackifying agent. The tackifying agent can aid in providing a secondary form of dust suppression, in sequestering loose particulates that are not otherwise bound in the polymer matrix. Suitable tackifying agents fall into three classes: rosin resins and rosin esters, hydrocarbon resins including hydrogenated hydrocarbon resins, and terpene resins. A suitable tackifying agent can be selected from the AQUATAC family of rosin esters, such as AQUATAC 6085 rosin ester, which is available from Arizona Chemical Co. as a dispersion of 60% solids. The tackifying agent preferably is included in an amount from about 1/100% to 1%, based on the weight of the water-soluble polymer.

The solution can optionally include nanoclays or other nanoscale particulate materials. The nanoparticulates, much like crosslinking agents, can enhance the water resistance and strength of the film formed from the polymer solution. Suitable nanoscale particulate materials include natural layered silicate materials (clays), including the smectite family of nanoclays, synthetic layered silicates (e.g., LAPONITE clay, available from Laporte Industries Plc, UK), nanocrystalline main group metal oxides, nanocrystalline rare earth oxides, nanocrystalline transition metal oxides, nanocrystalline mixed oxides of the foregoing; nanocrystalline main group metal phosphates and phosphonates, nanocrystalline transition metal phosphates and phosphonates, and nanocrystalline alkaline earth metal phosphates and phosphonates; nanocrystalline chalcogenide compounds; nanocrystalline fullerene aggregates, and combinations of any of the foregoing.

Preferred are hydrophilic nanoclays are selected from the smectite family of nanoclays (e.g., aliettite, beidellite, hectorite, montmorillonite, nontronite, saponite, sauconite, stevensite, swinefordite, volkonskoite, yakhontovite, and zincsilite). More preferred is a montmorillonite such as sodium montmorillonite. Sodium montmorillonite is available under the trade name CLOISITE NA from Southern Clay Products, Inc., of Gonzales, Tex. The nanoscale particulate material preferably is included in an amount from about 2 wt. % to about 5 wt. % of the solution on a dry basis.

In one type of embodiment, the solution can include a color agent, which can serve as an indicator for application. Colorants are known which remain colored in aqueous solution and which become clear upon drying. Absent a colorant, on many substrates the applied palliative will not be evident by visual inspection (e.g., appearing like a film).

In general, any suitable concentration of the solution described herein can be used, and potentially will vary depending on the apparatus used for application. For example, concentrations in the range of about 0.01 wt. % solids to about 20 wt. % solids are contemplated. For use in soil stabilization and dust abatement using solely or primarily wet applications (as defined below), the solution of water-soluble polymer and optional additives preferably has a solids content in a range of about 1 wt. % to about 20 wt. %, and more preferably in a range of about 4 wt. % to about 16 wt. %, for example 4 wt. %, 12 wt. %, or 16 wt. %. In applications where the fine particulate matter is especially fine (e.g., mining operations such as copper mines) the solids content can be as low as 1 wt. %. For use in soil stabilization and dust abatement using solely or primarily dry reapplications (as defined below), the solution of water-soluble polymer and optional additives preferably has a solids content in a range of about 0.01 wt. % to about 5 wt. %, and more preferably in a range of about 0.01 wt. % to about 2.5 wt. %, for example 0.03 wt. %, 0.1 wt. %, or about 2 wt. %.

The solution can be created by dissolving a solids mixture including the water-soluble polymer into water, or by diluting a prepared concentrated solution. Preferred forms of the solids mixture of components include spray-dried powders, pelletized solids, and flaked solids. The solids can be provided in a water-soluble bag made from the same or a different water-soluble polymer, which can then easily be dissolved in the field to yield a suitable solution.

### High Rate Application

In a high-rate embodiment, the rate of application of the solution is preferably such that it yields 10 g/m² to 150 g/m², on a dry basis, preferably 50 g/m² to 150 g/m².

The solution is preferably applied in such a manner as to yield a fine mist comprising substantially discrete droplets of solution, rather than flooding the substrate with solution, which would tend to cause runoff rather then an even penetration of solution into the soil. Application of a fine mist can be achieved with a boom sprayer, which is known in the art. Application methods include liquid pressure distribution, gravity flow distribution, and application by hand-held devices. Other applicators include spreaders, water tanks, tower guns, and the like, which are known in the art. In one embodiment, a spray apparatus will be positioned directly above the area being treated (e.g., at least about 14 inches; 36 cm, or in a range of about 14 inches to about 5 feet; 36 cm to 150 cm) to avoid driftage and runoff.

A fine droplet size of solution during application is especially preferred with solutions having relatively high concentration of polymer (e.g., 4 wt. % to 20 wt. %), to achieve suitable penetration into a substrate such as sand and avoid runoff. A relatively high viscosity solution (e.g., 1000 cP) is preferably diluted (e.g., to about 1 wt. % to about 8 wt. % polymer, such as 4 wt. % polymer) to yield a solution viscosity close to water (e.g., 1 cP to 40 cP).

Optionally, the substrate can be pre-wet with water or an aqueous solution lacking the water-soluble polymer (e.g., including a surfactant), prior to applying the solution having the water-soluble polymer.

In certain embodiments (e.g., stabilization of sand) it has been found that applying the solution to result in a depth of penetration in a range of about 7 mm to about 15 mm, or 8 mm to 10 mm, is preferred. The desired applied solids content can be achieved by one or more application steps onto the substrate. When more than one application step is performed, each reapplication step will be performed prior to the preceding application substantially drying. The method is believed to result in dust abatement of a class combining benefits of both surface blanket and surface penetrant types. It is believed that providing a relatively deep penetration of water-soluble polymer into a soil, rather than a relatively impermeable crust on only the outer layer of tens or hundreds of microns, is more environmentally friendly, for example by allowing insects to traverse the outer layer of soil.

### Low Rate Application

In an alternate embodiment, the solution is applied to a substrate at a lower rate than and, preferably, at a higher frequency than the high surface density application. One or more preferred application parameters, including spraying apparatus, droplet size, solution viscosity, substrate pre-wetting, and depth of penetration, are contemplated to be substantially the same as in the high surface density application.

In this embodiment, the solution is initially applied to the substrate and then preferably reapplied to the substrate at least once following at least partial drying (e.g. at least 50%), preferably at least substantial drying (e.g. at least 80%) of the previous application. Thus, a dry application/reapplication can be defined as an initial application or reapplication following at least partial drying (e.g. at least 50%), preferably at least substantial drying (e.g. at least 80%) of a previous application. Similarly, a wet reapplication can be defined as reapplication following insubstantial drying (e.g. less than 50%) of a previous application. If an application or reapplication step is performed with a plurality of spraying nozzles in a single pass in order to yield a target application rate of polymer, such an application pass is considered a single application.

According to the preferred method herein, the elapsed time between any two dry applications is preferably such that the solution applied in the first application of the pair substantially dries. For example, the elapsed time can be at least 6 hours, at least 12 hours, or at least 24 hours, or more. Accordingly, practice of the method preferably builds additional polymer on the substrate, rather than providing deeper penetration. Similarly, practice of the method preferably builds additional polymer on the substrate, rather than rebuilding or repairing a polymer that has been damaged or worn away. Thus, the elapsed time between the applications is preferably 96 hours or less, 72 hours or less, or 48 hours or less. Preferably, the surface will not be disturbed between dry re-applications, in order to maximize the integrity and effectiveness of the barrier. Thus, preferably intentional physical disturbances such as contact and load-bearing will be minimized or avoided between dry re-applications. Similarly, the elapsed time between the applications is preferably shorter especially when there are intervening disturbances such as high winds or unavoidable traffic on the substrate.

The rate of each application of the solution, whether for the initial application or for a dry reapplication, is such that it yields preferably at least 1 g/m², at least 2 g/m², or at least 9 g/m², all on a dry basis. Similarly, the rate of each application of the solution can be such that it yields preferably 50 g/m² or less, 10 g/m² or less, or 3 g/m² or less, all on a dry basis. Examples include about 2 g/m², about 9 g/m², and about 40 g/m².

Preferably, the total yield is at least 5 g/m², at least 10 g/m², or at least 30 g/m² for stabilization and/or dust abatement under typical atmospheric conditions. Examples include about 8 g/m² and about 36 g/m². Preferably, the total yield is at least about 20 g/m², at least about 40 g/m², or at least about 100 g/m² for stabilization and/or dust abatement in load-bearing or high wind conditions, all on a dry basis. Examples include about 36 g/m² and about 120 g/m². As it will be apparent from the disclosure herein, the yield is preferably greater on non-compacted or more loosely compacted substrates.

In another embodiment, the method can include both aspects of both high rate application (e.g., at least 10 g/m²) and dry reapplications, to yield a thicker, more durable surface barrier.

### Substrates

In one type of embodiment, the substrate will be one which is used for landing of aircraft, and optionally a zone of surrounding terrain. For example, the substrate can be a helipad, such as one which is temporarily required in a remote field of operation. In such cases, the substrate can include or consist essentially of sand, e.g. with no scars or vegitation. Other substrates contemplated for application include denuded areas around the periphery of construction projects; protective petroleum, oil and lubricant (PQL) dikes; magazine embankments of ammunition storage barricades; bunkers and revetments; cantonment, warehouse, storage, and housing areas; unimproved grounds including unimproved roads; shoulders and overruns of airfields; shoulders, hover lanes, and peripheral areas of heliports and helipads; and racetracks. The method is particularly suited to application on flat or moderately sloped terrain having no vegetation or gravel.

Without intending to be limited by any particular theory, it is believed that after curing, the water-soluble polymer and optional additives, in the amount described herein, acts like a net—impregnating the unbound or non-compacted soil overlaying the soft to firm sub-grade. It is further believed that the use of an anionic polymer having alkaline earth metal counterions can increase adhesion to silicates, such as sand particles. Because the polymer is not crosslinked (or in one variation is only moderately crosslinked), the resultant system is relatively flexible, especially when a plasticizer is used. The resulting soil is resistant to rutting and helicopter downwash.

Various embodiments of the method and solution described herein can optionally yield one or more advantages. For example, the method described herein can provide a solution which is convenient and easy to apply, which reduces waste, and which yields stabilization which is easy to repair. The method can be employed in one class of embodiments to provide a solution which requires much less water than comparable methods, for example ¼ to ⅓ the water of methods employing polyvinyl acetate emulsions. Less water used results in a direct benefit of providing a shorter curing time (e.g., less water to evaporate). Application equipment can be washed out by hot or cold water; no organic thinners are necessary, and equipment is not corroded by the solution. The solution is non-toxic, and skin contact is not hazardous.

### EXAMPLES

The following examples are provided for illustration and are not intended to limit the scope of the invention.

### Examples 1 and 2

Solutions of PVOH water-soluble polymer in water were applied to a sandy substrate in the amounts shown in Table 1, to evaluate their performance in dust abatement.

TABLE 1

| | | Application rate, | |
|---|---|---|---|
| | Solution | wet basis | Application rate, |
| Area No. | Concentration | (gal/acre; liter/m²) | dry basis (g/m²) |
| 1 | 4% | 1,495; 1.40 | 56 |
| 2 | 4% | 2,991; 2.81 | 111 |

Tests were performed on desert land located in Yuma, Ariz. The soil was firm sand, generally lacking rocks and vegetation. The base polymer formula included PVOH, plasticizers including glycerin, surfactants, and other minor components including starch. The solutions were applied using a 30 foot (9.1 meters) agricultural chemical boom spray bar mounted on a truck. The bar had five type 120 spray nozzles disposed at intervals of 5 feet (1.5 meters) along the boom and at 5 feet (1.5 meters) above the soil. The fluid pressure was 20 psi. The spray pattern for each nozzle was approximately 5 feet (1.5 meters) in width. The depth of penetration ranged from ⅓ inch to ⅜ inch (7 mm to 9.5 mm).

Dust abatement tests were performed 20 hours after application of the polymer solutions. Dust abatement was evaluated by having a Bell C58 helicopter hover over a treated area measuring 90 feet by 120 feet (about 27 m by about 37 m). Its rotorwash was estimated to generate winds up to about 90 mph (about 145 km/hr). The helicopter approached the center of each test area and descended from 100 ft (31 m) to the ground, pausing at 25 ft (8 m) for 10 seconds to 15 seconds. After having touched the ground, the helicopter ascended, hovering for 10 second to 20 seconds as close to the ground as possible before leaving the area.

Both areas showed good dust abatement quality: after a few seconds for the helicopter to displace dust brought into the area after application of the palliative, there was no visible sign of dust coming from the areas. The rotorwash of the helicopter did create airborne dust from areas immediately adjacent the test areas, demonstrating a clear difference in quality.

Minor ruts were created by the helicopter landing pads on both areas, with the imprint being smaller on area 2. The ruts in both areas were repaired using plain water.

Both areas were driven on by a 4000 lb vehicle (1.81 metric ton) vehicle without creation of ruts or other surface modification.

### Examples 3 & 4

### Example 3

A quantity of 0.75 gallons (2.81) of an 8% solution of PVOH was mixed with 230 gallons (871 l) of water to yield a 0.03% solution. The base polymer formula included PVOH, plasticizers including glycerin, surfactants, and other minor components including starch. The solution was applied on a 74 yard×30 foot (68 m×9.1 m) surface of moderately coarse, sandy soil using a boom sprayer having multiple nozzles. The surface area was ⅔ medium compacted and ⅓ loosely compacted. The application was repeated every 24 hours for 4 days, building up 4 layers of 2.1 g/m² each of dry product. The speed of the vehicle used to apply solution was 0.47 mph (0.76 km/hr) and the pump output was 2.25 gps (8.52 l/s), providing a finished application equivalent to about 1,500 gpa (1.4 l/m²) of total mix.

### Example 4

A quantity of 3 gallons (11.41) of an 8% solution of PVOH was mixed with 230 gallons (871 l) of water to yield a 0.1% solution. The base polymer formula included PVOH, plasticizers including glycerin, surfactants, and other minor components including starch. The solution was applied on a 70 yard×30 foot (64 m×9.1 m) surface of moderately coarse, sandy soil using a boom sprayer having multiple nozzles. The surface area was ⅔ medium compacted and ⅓ loosely compacted. The application was repeated every 24 hours for 4 days, building up 4 layers of 8.8 g/m² each of dry product. The speed of the vehicle used to apply solution was 0.47 mph (0.76 km/hr) and the pump output was 2.25 gps (8.52 l/s), providing a finished application equivalent to about 1,600 gpa (1.5 /m²) of total mix.

A pickup truck was driven on the treated surfaces of Examples 3 and 4 after the fifth day. On the surface of Example 3, the vehicle broke the light crust on both the compact and the loose part of the surface and formed dust where the tires tracks were. On the surface of Example 4, the vehicle did not brake the crust on the compacted area, but did on the loose area. In both Experiments the resulting crust was enough to avoid dust from being airborne by wind (about 30-35 mph, 48-56 km/hr).

### Example 5

A quantity of 270 gallons (1020 l) of a 16% solution of PVOH was mixed with 1730 gallons (6550 l) of water to yield 2,000 gal (7570 l) of a 2.16% solution. The base polymer formula included PVOH, plasticizers including glycerin, surfactants, and other minor components including starch. A water truck containing the solution was used to treat an un-compacted dirt access road. The road received three applications of solution, each at a rate of 270 gpa (41 gr/m² of dried product). As with Examples 3 and 4, the second and third applications were made after allowing the previous applications to dry. The result showed an excellent ability to carry load. Two hundred vehicle weighing about tons each drove on it in the week after the applications, without creation of ruts or dust.

The foregoing description is given for clearness of understanding only, and no unnecessary limitations should be understood therefrom, as modifications within the scope of the invention may be apparent to those having ordinary skill in the art.

Throughout the specification, where compositions are described as including components or materials, it is contemplated that the compositions can also consist essentially of, or consist of, any combination of the recited components or materials, unless described otherwise.

The practice of a method disclosed herein, and individual steps thereof, can be performed manually and/or with the aid of electronic equipment. Although processes have been described with reference to particular embodiments, a person of ordinary skill in the art will readily appreciate that other ways of performing the acts associated with the methods may be used. For example, the order of various of the steps may be changed without departing from the scope or spirit of the method, unless described otherwise. In addition, some of the individual steps can be combined, omitted, or further subdivided into additional steps.

What is claimed is:

1. A method of dust abatement, comprising:
applying to a surface comprising particulate material a single-phase solution comprising a water-soluble polymer selected from the group consisting of polyvinyl alcohol, derivatives thereof, and combinations thereof, at a rate of 10 g/m² to 150 g/m², on a dry basis.

2. The method according to claim 1, comprising applying the solution at a rate of 50 g/m² to 150 g/m², on a dry basis.

3. The method according to any one of the preceding claims, wherein the solution comprises 0.01 wt. % to 20 wt. % solids.

4. The method according to claim 3, wherein the solution comprises 4 wt. % to 16 wt. % solids.

5. The method according to any one of the preceding claims, wherein the applying comprises a first application step and at least one wet reapplication step.

6. A method of dust abatement, comprising:
applying to a surface comprising particulate material in a first application step a single-phase solution comprising a water-soluble polymer selected from the group consisting of polyvinyl alcohol, derivatives thereof, and combinations thereof, at a rate of 1 g/m² to 50 g/m², on a dry basis; and
re-applying the solution in a second application step after the first application of solution has at least partially dried.

7. The method according to claim 6, wherein the re-applying is performed after the first application of solution has at least substantially dried.

8. The method according to claim 6, wherein the re-applying is performed at least about 6 hours after the first application.

9. The method according to claim 8, wherein the re-applying is performed up to 48 hours after the first application.

10. The method according to any one of claims 6 to 9, wherein the re-applying is performed at a rate of 1 g/m² to 50 g/m², on a dry basis.

11. The method according to any one of claims 6 to 10, wherein the re-applying is performed prior to optionally physically disturbing the surface.

12. The method according to any one of claims 6 to 10, wherein the total yield of solution is at least 5 g/m², on a dry basis.

13. The method according to claim 12, wherein the total yield of solution is at least 20 g/m², on a dry basis.

14. The method according to any one of claims 6 to 13, wherein the solution comprises 0.01 wt. % to 20 wt. % solids.

15. The method according to claim 14, wherein the solution comprises 0.01 wt. % to about 5 wt. % solids.

16. The method according to any one of the preceding claims, wherein the solution further comprises a plasticizer.

17. The method according to claim 16, wherein the plasticizer is present in an amount in a range from 5 wt. % to 40 wt. % of the composition, on a dry basis.

18. The method according to any one of the preceding claims, wherein the solution further comprises a surfactant.

19. The method according to any one of the preceding claims, wherein the solution further comprises a tackifying agent.

20. The method according to any one of the preceding claims, wherein the solution further comprises a nanoscale particulate material.

21. The method according to claim 20, wherein the nanoscale particulate material is present in an amount in a range of about 2 wt. % to about 5 wt. % of the solution on a dry basis.

22. The method according to claim 20 or 21, wherein the nanoscale particulate material is selected from the group consisting of hydrophilic smectite nanoclays, and combinations thereof.

23. The method according to any one of the preceding claims, wherein the water-soluble polymer provides a 4% solution viscosity in a range of 5 cP to 40 cP at 20° C.

24. The method according to any one of the preceding claims, wherein the applying comprises spraying the solution to create a mist comprising substantially discrete droplets.

25. The method according to any one of the preceding claims, wherein the applying results in a depth of penetration of the solution into the surface in a range of 7 mm to 15 mm.

26. The method according to any one of the preceding claims, further comprising first applying water to the surface prior to applying the solution.

27. The method according to any one of the preceding claims, wherein the particulate material is sand.

28. The method according to any one of the preceding claims, wherein the water-soluble polymer is soluble in cold water.

29. The method according to any one of the preceding claims, wherein the solution further comprises less than 5 wt. % of a crosslinking agent, based on the weight of the water-soluble polymer, selected from the group consisting of those that form complexes via labile polar covalent interactions, those that crosslink via ionic interactions, those that crosslink via hydrogen bonding interactions, and combinations of such crosslinking agents.

30. The method according to any one of the preceding claims, wherein the solution further comprises less than 5 wt. % of a crosslinking agent, based on the weight of the water-soluble polymer, selected from the group consisting of borates, boric acid, ammonium zirconium carbonate, inorganic polyions, Group 1B salts, polyamide-epichlorohydrin resin, and combinations thereof.

31. The method according to claim 30, wherein the crosslinking agent comprises boric acid.

32. The method according to any one of claims 1 to 28, wherein the solution is essentially free of crosslinking agents for the water-soluble polymer
